(19) United States
(12) Patent Application Publication
(10) Pub. No.: US 2020/0015623 A1
(43) Pub. Date: Jan. 16, 2020

(54) ROBOT SYSTEM AND CONTROL METHOD OF THE SAME

(71) Applicant: LG ELECTRONICS INC., Seoul (KR)

(72) Inventor: Jungsik KIM, Seoul (KR)

(21) Appl. No.: 16/579,943

(22) Filed: Sep. 24, 2019

(30) Foreign Application Priority Data
Aug. 30, 2019 (KR) 10-2019-0107561

(51) Int. Cl. A47J 36/32; B25J 9/00; B25J 11/00; A47J 44/00; A23L 5/10

(52) U.S. Cl. CPC A47J 36/32; B25J 9/0096; A23V 2002/00; A47J 44/00; A23L 5/10; B25J 11/0085

(57) ABSTRACT

A robot system includes a robot having an end effector, to which a cooking utensil is detachably connected, a washer having formed therein a washing space in which the cooking utensil is washed, a controller configured to operate the robot in a washing mode in which the cooking utensil is inserted into the washing space and then is washed in the washing space.

### CROSS-REFERENCE TO RELATED APPLICATIONS

This application claims the benefit of priority to Korean Patent Application No. 10-2019-0107561, filed in the Korean Intellectual Property Office on Aug. 30, 2019, the entire contents of which are incorporated herein by reference.

### FIELD OF THE DISCLOSURE

The present disclosure relates to a robot system and a control method of the same.

Robots are machines that automatically process given tasks or operate with their own capabilities. The application fields of robots are generally classified into industrial robots, medical robots, aerospace robots, and underwater robots. Recently, communication robots that can communicate with humans by voices or gestures have been increasing.

Recently, a cooking robot capable of cooking by using a robot is gradually increased and an example of such a robot is a cooking assistant robot disclosed in Japanese Patent Publication No. 4531832 (published on Aug. 25, 2010).

The cooking assistant robot disclosed in Japanese Patent Publication No. 4531832 is a robot that assists cooking using a cooking container disposed on a cooking burner, and includes a hand part, an arm part for changing the position and posture of the hand part, and a support part for supporting the arm part as well as at least six movable parts capable of arbitrarily changing the position and posture of the hand part.

### SUMMARY

Embodiments provide a robot system capable of rapidly washing a cooking utensil and a method of controlling the same.

A robot system according to an embodiment includes a robot having an end effector, to which a cooking utensil is detachably connected, a washer having formed therein a washing space in which the cooking utensil is washed, and a controller configured to operate the robot in a washing mode in which the cooking utensil is inserted into the washing space and then is washed in the washing space.

In the washing mode of the robot, the controller may move the end effector to an insertion trajectory where the cooking utensil is inserted into the washing space, and then operate the end effector in a washing motion.

An angle at which the end effector inserts the cooking utensil into the washing space may be determined according to a type of the cooking utensil and a type of the washer.

During the washing mode of the robot, the controller may rotate the end effector in a rotational motion in which the end effector rotates above the washing space.

During the washing mode of the robot, the controller may lift up or lower down the end effector in an elevating motion in which the end effector is lifted up or lowered down above the washing space a plurality of times.

When the washing mode of the robot is finished, the controller may move the end effector to a withdrawal trajectory where the cooking utensil is withdrawn from the washing space.

When the washing mode of the robot is finished, the controller may put the cooking utensil into a sink or a dishwasher.

The washer may be spaced apart from the robot by a first distance, and the first distance may be less than a maximum length of the robot.

The washer may include a washer controller configured to control the washer, and a communication device configured to communicate with the robot.

The washer may include a washing housing having an opened upper surface and having the washing space formed therein, and a plurality of nozzles disposed in the washing housing to spray wash water toward the washing space.

The washer may include a washing housing having an opened upper surface and having the washing space formed therein, and at least one washing roller disposed to advance to or retreat from the washing space in the washing housing.

A method of controlling a robot system may control the robot system including a robot having an end effector, to which a cooking utensil is detachably connected, and a washer having formed therein a washing space in which the cooking utensil is washed.

The method of controlling the robot system may include performing cooking operation using the cooking utensil by the robot, inserting the cooking utensil into the washing space by the end effector, operating the end effector in a washing motion, and withdrawing the cooking utensil from the washing space by the end effector.

The inserting of the cooking utensil may include moving the end effector to an insertion trajectory where the cooking utensil is inserted into the washing space.

The inserting of the cooking utensil may include determining an angle, at which the end effector inserts the cooking utensil into the washing space, according to a type of the cooking utensil and a type of the washer.

In the washing motion, the end effector may rotate above the washing space.

In the washing motion, the end effector may be lifted up or lowered down above the washing space a plurality of times.

The operating of the end effector in the washing motion may include spraying wash water toward the washing space by a plurality of nozzles of the washer.

The operating of the end effector in the washing motion may include moving a washing roller of the washer in the washing space.

The withdrawing of the cooking utensil may include moving the end effector to a withdrawal trajectory where the cooking utensil is withdrawn from the washing space.

The method may further include, after the withdrawing of the cooking utensil, moving the end effector to a movement trajectory where the cooking utensil is put into a sink or a dishwasher.

### BRIEF DESCRIPTION OF THE DRAWINGS

FIG. 1 is a view illustrating an Al device constituting a robot system according to an embodiment.

FIG. 2 is a view illustrating an Al server of a robot system according to an embodiment.

FIG. 3 is a view illustrating an Al system to which a robot system according to an embodiment is applied.

FIG. 4 is a view showing a robot and a washer of a robot system according to an embodiment.

FIG. 5 is a view showing the case where the robot shown in FIG. 4 introduces a cooking utensil into the washer.

FIG. 6 is a cross-sectional view of the washer when the robot shown in FIG. 5 introduces the cooking utensil into the washer.

FIG. 7 is a view showing the case where the robot shown in FIG. 6 withdraws the cooking utensil from the washer.

FIG. 8 is a view showing the case where the robot shown in FIG. 7 moves the cooking utensil to a sink.

FIG. 9 is a flowchart illustrating a method of controlling a robot system according to an embodiment.

### DETAILED DESCRIPTION OF THE EMBODIMENTS

Hereinafter, preferred embodiments of the present disclosure will be described in detail with reference to the drawings.

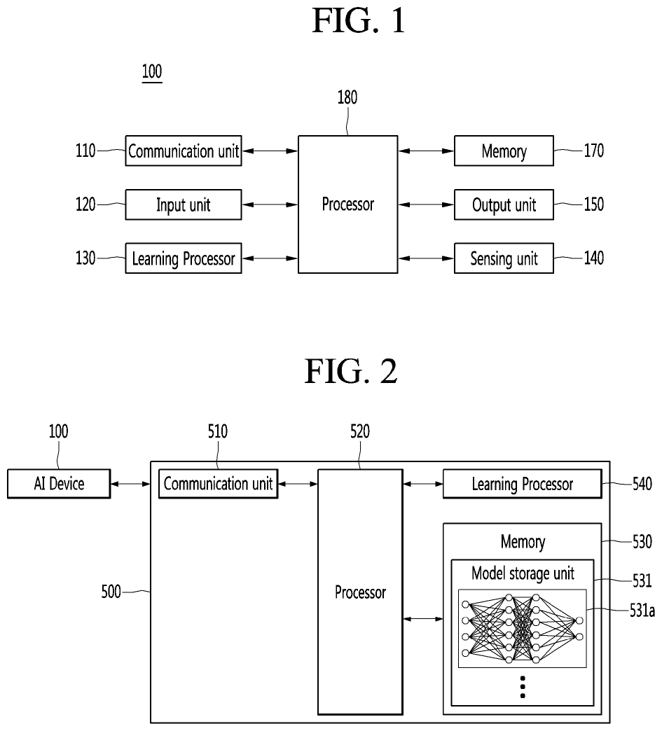

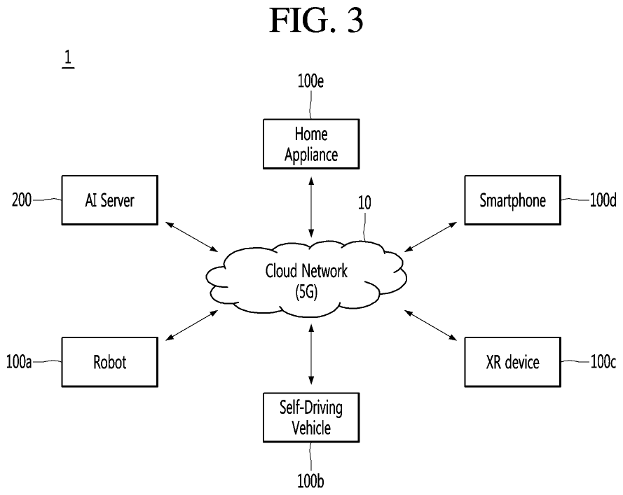

FIG. 1 is a view illustrating an Al device constituting a robot system according to an embodiment, FIG. 2 is a view illustrating an Al server of a robot system according to an embodiment and FIG. 3 is a view illustrating an Al system to which a robot system according to an embodiment is applied.

### Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

### Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

FIG. 1 illustrates an AI device 100 including a robot according to an embodiment of the present disclosure.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 500 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform Al processing together with the learning processor 540 of the AI server 500.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 540 of the AI server 500, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 500. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 500 connected to a robot according to an embodiment of the present disclosure.

Referring to FIG. 2, the AI server 500 may refer to a device that learns an artificial neural network by using a machine learning algorithm or uses a learned artificial neural network. The AI server 500 may include a plurality of servers to perform distributed processing, or may be defined as a 5G network. At this time, the AI server 500 may be included as a partial configuration of the AI device 100, and may perform at least part of the AI processing together.

The AI server 500 may include a communication unit 510, a memory 530, a learning processor 540, a processor 520, and the like.

The communication unit 510 can transmit and receive data to and from an external device such as the AI device 100.

The memory 530 may include a model storage unit 531. The model storage unit 531 may store a learning or learned model (or an artificial neural network 531a) through the learning processor 540.

The learning processor 540 may learn the artificial neural network 531a by using the learning data. The learning model may be used in a state of being mounted on the AI server 500 of the artificial neural network, or may be used in a state of being mounted on an external device such as the AI device 100.

The learning model may be implemented in hardware, software, or a combination of hardware and software. If all or part of the learning models is implemented in software, one or more instructions that constitute the learning model may be stored in memory 530.

The processor 520 may infer the result value for new input data by using the learning model and may generate a response or a control command based on the inferred result value.

FIG. 3 illustrates an AI system 1 according to an embodiment of the present disclosure.

Referring to FIG. 3, in the AI system 1, at least one of an AI server 500, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 500 configuring the AI system 1 may be connected to each other through the cloud network 10. In particular, each of the devices 100a to 100e and 500 may communicate with each other through a base station, but may directly communicate with each other without using a base station.

The AI server 500 may include a server that performs AI processing and a server that performs operations on big data.

The AI server 500 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 500 may learn the artificial neural network according to the machine learning algorithm instead of the AI devices 100a to 100e, and may directly store the learning model or transmit the learning model to the AI devices 100a to 100e.

At this time, the AI server 500 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

### AI+Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 500.

At this time, the robot 100a may perform the operation by generating the result by directly using the learning model, but the sensor information may be transmitted to the external device such as the AI server 500 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

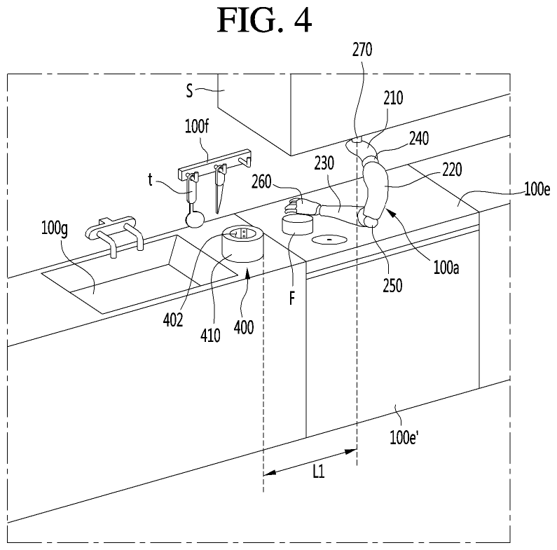

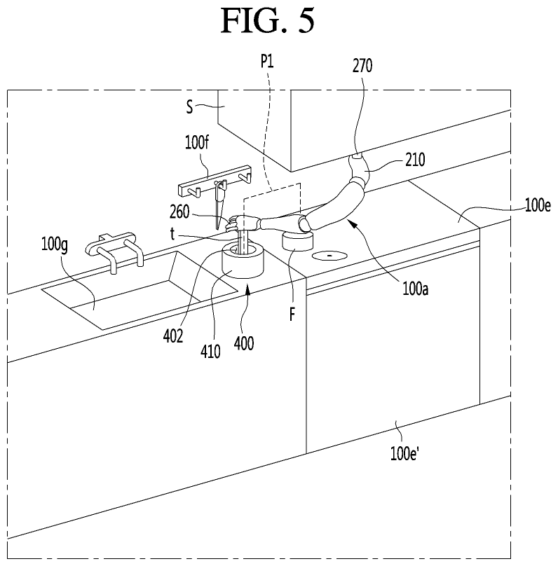

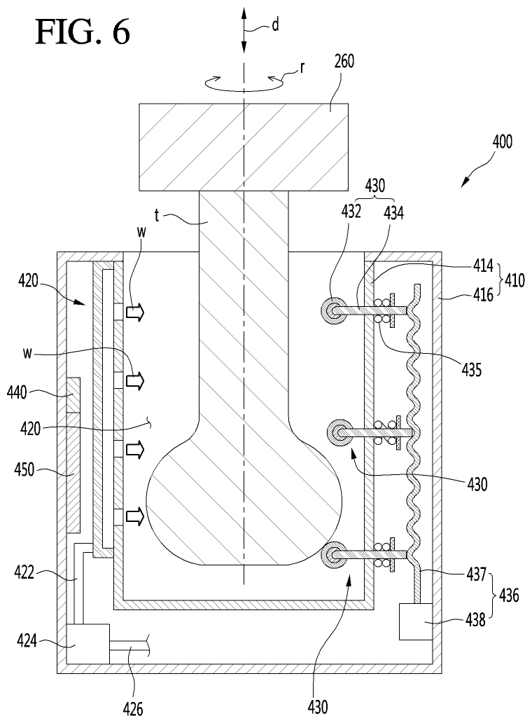

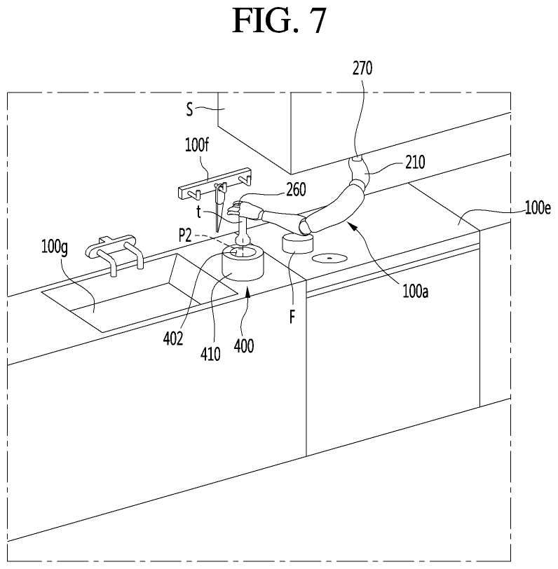

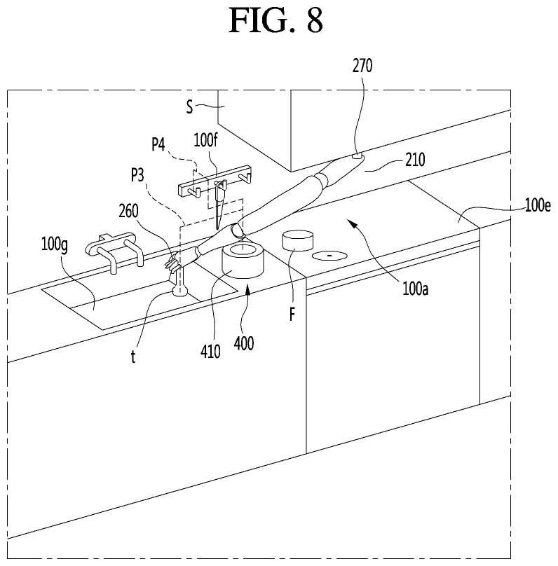

FIG. 4 is a view showing a robot and a washer of a robot system according to an embodiment, FIG. 5 is a view showing the case where the robot shown in FIG. 4 introduces a cooking utensil into the washer, FIG. 6 is a cross-sectional view of the washer when the robot shown in FIG. 5 introduces the cooking utensil into the washer, FIG. 7 is a view showing the case where the robot shown in FIG. 6 withdraws the cooking utensil from the washer, and FIG. 8 is a view showing the case where the robot shown in FIG. 7 moves the cooking utensil to a sink.

The robot 100a may perform various cooking operations such as cutting, stirring, ingredient movement, etc. using various cooking utensils (hereinafter, referred to as a cooking utensil) such as a knife, a cutting board, a pot, a ladle, a frying pan, etc.

The robot 100a may include at least one robot arm. The robot 100a may include a pair of robot arms.

The robot 100a may include a plurality of arms 210, 220 and 230 and at least one arm connectors 240 and 250 for connecting the plurality of arms, performing the various cooking operations. The plurality of arms 210, 220 and 230 may be sequentially disposed with the arm connectors 240 and 250 interposed therebetween.

The robot 100a may further include an end effector 260 installed in any one 230 of the plurality of arms 210, 220 and 230.

The end effector 260 may be a robot hand or a gripper and may be installed on the distal end of the robot 100a such that the robot 100a performs various cooking-related functions (hereinafter referred to as cooking operation).

The robot 100a may include at least one motor or actuator capable of rotating the arms 210, 220 and 230, the arm connectors 240 and 250 and the end effector 260.

If the robot arm R configuring the robot arm 100a is capable of three-dimensionally moving and rotating the end effector 260, the shapes or numbers of arms 210, 220 and 230, arm connectors 240 and 250, and motors or actuators are not limited thereto and may be variously changed.

The robot arm 200 may further include a robot connector 270 for connecting another 210 of the plurality of arms 210, 220 and 230 to another object.

The other object, to/by which the robot connector 270 is connected/supported, may be an ingredient module (not shown) provided in a room in which a cooking device 100e is installed to feed an ingredient necessary for cooking to the robot 100a. In this case, the ingredient module may feed the ingredient to the robot 100a, and the robot 100a may receive the ingredient from the ingredient module and use the ingredient for cooking.

The other object, to/by which the robot connector 270 is connected/supported, may be furniture S such as a shelf or a storage cabinet provided in a room in which the cooking device 100e is installed or an ingredient module case provided in the room, in which the cooking device 100e is installed, and having an ingredient module received therein.

The end effector 260 of the robot 100a may three-dimensionally move or rotate the cooking utensil t in a state of being connected with the cooking utensil t.

The cooking utensil t may be detachably connected to the end effector 260.

The robot 100a may grip the cooking utensil t located on a cooking utensil holder such as a shelf or a hanger using the end effector 260 or fit the cooking utensil t into the end effector 260 to integrate the cooking utensil with the end effector 260 and perform various cooking operations using the cooking utensil t while three-dimensionally moving and rotating the end effector 260.

Hereinafter, connection between the cooking utensil t and the end effector 260 may be defined as fixing the cooking utensil t to the end effector 260 such that the cooking utensil t is moved or rotated integrally with the end effector 260, and may include the end effector 260 gripping the cooking utensil t or fitting the cooking utensil t into the end effector 260.

The robot 100a may perform various cooking operations using the cooking utensil t around the cooking device 100e, a cooking utensil holder 100f, a sink 100g and a dishwasher 100e′, and a washer 400.

The cooking device 100e may be a home appliance for heating a cooking container F placed thereon or therein, a gas stove for heating the cooking container F (hereinafter referred to as the cooking container F) such as a frying pan or a pot using gas or an electric stove for heating the cooking container F placed thereon by an induction heater or an electric heater.

The robot 100a may perform cooking operation of cooking food while three-dimensionally moving or rotating the cooking utensil t above the cooking device 100e or a cutting board.

The robot 100a may wash the cooking utensil t in the washer 400 or move the cooking utensil t to the sink 100g or the dishwasher 100e′, after performing cooking operation on the cooking device 100e or the cutting board.

The robot 100a may put the cooking utensil t into the washer 400 to perform washing to remove various residues from the cooking utensil t.

The robot 100a may withdraw the cooking utensil t preliminarily washed in the washer 400 from the washer 400 (preliminary washing) and then put the cooking utensil t into the sink 100g or the dishwasher 100e′, and the robot 100a or a user may secondarily wash the cooking utensil t using water and a detergent (main washing).

The robot 100a may perform operation of moving the cooking utensil t to the cooking utensil holder 100f and then holding the cooking utensil t on the cooking utensil holder 100f.

The robot 100a may perform cooking operation of cooking food using the cooking utensil t, washing operation of washing the cooking utensil t using a washer 400, holding operation of holding the cooking utensil t on the cooking utensil holder 100f, movement operation of moving the cooking utensil t to the sink 100g or the dishwasher 100e′, washing operation in which the robot 100a washes the cooking utensil tin the sink 100g using water and a detergent, and manipulation operation in which the robot 100a manipulates the dishwasher 100e′.

For example, the robot 100a may introduce the cooking utensil t into the washer 400 to perform washing, perform new cooking operation again using the washed cooking utensil t, hold the washed cooking utensil t on the cooking utensil holder H, or move the cooking utensil to the sink 100g or the dishwasher 100e′, after cooking operation using the cooking utensil t is performed.

In the washer 400, a washing space 402 in which the cooking utensil t is washed may be formed. The washer 400 may simply wash the cooking utensil t and may be separate from the dishwasher 100e′.

The washer 400 may be spaced apart from the robot 100a by a first distance L1. The first distance L1 may be less than a maximum length of the robot 100a.

The first distance L1 may be defined as a distance between a portion of the robot 100a connected to another object S and the washer 400.

The washer 400 may be disposed at a position where the cooking utensil t connected to the robot 100a may be reached.

The washer 400 may remove a foreign object from the cooking utensil t by a high-pressure fluid or friction without using a separate detergent.

The dishwasher 100e′ may wash the cooking utensil t using the detergent, and the washer 400 and the dishwasher 100e′ may be distinguished depending on whether the detergent is used or not or presence/absence of a detergent supply portion.

The washer 400 may include a washing housing 410 having an opened upper surface and having a washing space 402 formed therein. The washing housing 410 may include an inner body 414 in which the washing space 402 is formed and an outer body 416 disposed outside the inner body 414.

The washer 400 may include at least one nozzle 420 disposed in the washing housing 410 to spray wash water such as water or high-pressure air toward the washing space 402. A plurality of nozzles 420 may be provided in the washing housing 410, and the plurality of nozzles 420 may be disposed to be spaced apart from the inner body 414. The nozzles 420 may spray wash water or air toward the washing space 402 and, more particularly, the center of the washing space 402.

The washer 400 may include a supply tube 422 connected to the nozzles 420, a water pump 424 connected to the supply tube 422 and a water supply tube 426 connected to the water pump 424.

The water supply tube 426 may be connected to guide water W of a water tank (not shown) to the water pump 424 and may be connected to a faucet to guide water to the water pump 424.

When the water pump 424 is driven, water supplied through the water supply tube 426 may be sprayed to the washing space 402 through the nozzles 420 at high pressure.

The washer 400 may include a supply tube connected to the nozzles 420 and an air pump connected to the supply tube, and spray external air to the washing space 402 through the nozzles 420 at high pressure when the air pump is driven.

Although the washer 400 includes the supply tube 422, the water pump 424 and the water supply tube 426, and high-pressure wash water, which has passed through the nozzle 420, is sprayed to the washing space 402 in FIG. 6, the washer 400 of the present embodiment may spray not only high-pressure wash water but also high-pressure air to the washing space 402.

The washer 400 may include at least one washing roller 430 disposed to advance to and retreat from the washing space 402 in the washing housing 410. The washing roller 430 may include a washing brush 432 rubbing with the cooking utensil t introduced into the washing space 402. The outer circumference of the washing brush 432 may be formed of a soft material such as fabric.

The washing roller 430 may include a support 434 connected to the washing brush 432 to support the washing brush 432. The washing roller 430 may further include an elastic member 435, such as a spring, which elastically supports the support 434.

The support 434 may be pulled by the elastic member 435 in a direction retreating toward the outer body 416.

A plurality of washing rollers 430 may be provided in the washing housing 410. The plurality of washing rollers 430 may be spaced apart from each other in a vertical direction or a horizontal direction.

The washer 400 may include a support movement device 436 for linearly moving the support 434.

The support movement device 436 may move the support 434 such that the support 434 advances toward the center of the washing space 402 or retreats toward the outer body 416.

The support movement device 436 may include a driving shaft 437 including a recess, into which one end of the support is capable of being inserted, and a protrusion capable of pushing one end of the support toward the center of the washing space 402, and a motor 438 such as a linear motor for rotating or moving the driving shaft 437, a solenoid valve, a server motor or a step motor.

The washer 400 may further include a communication device 400 communicating with the robot 100a. The communication device 400 may be disposed in the washing housing 410, and may communicate with the communication unit 110 of the robot 100a, the communication unit 510 of the server 500 or the terminal such as a smartphone by wires or wirelessly.

The washer 400 may further include a washer controller 450 for controlling the washer 400. The washer controller 450 may receive a signal through the communication device 400 and control the water pump 424 or the motor 438.

The washer 400 may wash the cooking utensil t in cooperation with the robot 100a, and the washer 400 and the robot 100a may cooperatively and three-dimensionally wash the cooking utensil t.

The washer controller 450 may drive the water pump 424 or the motor 438 at the time of rotation or elevation of the end effector 260.

The washer controller 450 may drive the pump 424 or the motor 438, when a starting condition is satisfied, for example, the cooking utensil t reaches the upper side of the washing space 402 or the cooking utensil t is completely introduced into the washing space 402. When the pump 424 or the motor 438 is driven, the washer controller 450 may continuously drive the pump 424 or the motor 438 or repeatedly drive and stop the pump 424 or the motor 438 with a set period.

The washer controller 450 may stop the pump 424 or the motor 438, when a releasing condition is satisfied, for example, the pump 424 or the motor 438 is driven during a set time or the cooking utensil t is completely lifted up to the upper side of the washing space 402.

The robot 100a may be controlled by a controller. The robot may configure an AI device for performing motion operations using an artificial neural network and may generate various motions by data prestored in the memory 170 and the program of the processor 180 without using the artificial neural network.

Hereinafter, the controller will be denoted by the same reference numeral 180 as the processor, for convenience.

The controller 180 may select one of a plurality of recipes stored in the memory 170 according to cooking information input through the input unit 120, search for a recipe according to cooking information input by the user using the artificial neural network or download a recipe from the server 500 and store the recipe in the memory 170.

The controller 180 may control the robot 100a and the washer 400 in a washing mode, during cooking operation using the robot 100a.

In the washing mode of the robot 100a, the controller 180 may move the end effector 260 to move the cooking utensil t to a trajectory P1 (insertion trajectory P1) where the cooking utensil t is inserted into the washing space 402.

The controller 180 may calculate a trajectory where the cooking utensil t may be inserted into the washer 400 using information on the position coordinates (X, Y, Z) of the end effector 160, information on the direction of the end effector 160 and information on the position coordinates (X, Y, Z) of the washer 400. The controller 180 may control the robot 100a such that the cooking utensil t moves along the calculated trajectory P1 (see FIG. 5).

An angle at which the end effector 260 inserts the cooking utensil t into the washing space 402 may be determined according to the type of the cooking utensil t and the type of the washer 400.

The cooking utensil t which may be washed by the robot 100a and the washer 400 may include various types of cooking utensils and various types of cooking utensils may have different lengths, widths or shapes.

The type of the cooking utensil t may be used as a factor for determining the angle at which the cooking utensil t is inserted into the washing space 402.

The size or shape of the washing space 402 may vary according to the manufacturer or model of the washer 400, and the type of the washer 400 may be used as a factor for determining the angle θ at which the cooking utensil t is inserted into the washing space 402.

The controller 180 may calculate an optimal insertion angle of the cooking utensil t connected to the end effector 260 using the artificial neural network.

In the washing mode of the robot 100a, the controller 180 may operate the end effector 260 in a washing motion.

During the washing mode of the robot 100a, the controller 180 may operate the end effector 260 in a rotational motion r in which the end effector 260 rotates above the washing space 402.

During the washing mode of the robot 100a, the controller 180 may operate the end effector 260 in an elevating motion d in which the end effector 260 is lifted up or lowered down above the washing space 402 a plurality of times.

The robot 100a may be controlled such that the cooking utensil t is withdrawn from the washing space 402, when the washing mode is finished. The controller 180 may move the end effector 260 to a trajectory P2 (withdrawal trajectory P2; see FIG. 6) where the cooking utensil t is withdrawn from the washing space 402. The controller 180 may control the robot 100a such that the cooking utensil t is moved along the calculated trajectory P2.

The sensing unit 140 of the robot 100a may determine a degree of washing by the washer 400, and the sensing unit 150 may include an RGB-D camera sensor capable of sensing the shape, color, thickness, etc. of the cooking utensil t.

The robot system may acquire an image (hereinafter referred to as a first image) of the cooking utensil t before the cooking process is performed, an image (hereinafter referred to as a second image) of the cooking utensil t after the cooking process is performed, an image (hereinafter referred to as a third image) of the cooking utensil t withdrawn from the washer 400, by the RGB-D camera sensor.

The controller 180 may compare the images before and after washing by the washer 400, and check the degree of washing by the washer 400.

The controller 180 may compare the third image with the first image or the second image to determine whether foreign object remains on the cooking utensil t.

The controller 180 may insert the cooking utensil t into the washer 400 again, when the amount of foreign object on the cooking utensil t exceeds a set value after washing by the washer 400 and the robot 100a.

The controller 180 may repeatedly perform the above-described process with respect to the cooking utensil t, and finish preliminary washing by the washer 400 when the amount of foreign object on the cooking utensil t is less than the set value.

When the washing mode of the robot 100a is finished, the robot 100a may put the cooking utensil t into the sink 100g or the dishwasher 100e′ such that the cooking utensil t withdrawn from the washing space 402 is further washed. To this end, the controller 180 may move the end effector 260 such that the cooking utensil t is placed in the sink 100g or put into the dishwasher. The controller 180 may calculate a trajectory P3 (movement trajectory P3) where the cooking utensil t is placed in the sink 100g or moved to the dishwasher.

The controller 180 may control the robot 100a such that the cooking utensil t is moved along the calculated trajectory P3.

The controller 180 may compare the third image with the first image to determine the state of the cooking utensil t, after the washing process by the washer 400.

The controller 180 may calculate the amount of foreign object remaining on the cooking utensil t from the third image and the first image, and control the robot 100a such that the cooking utensil t is moved to the movement trajectory P3, when the calculated amount of foreign object is less than the set value but is equal to or greater than a lower limit value.

Meanwhile, when the washing mode of the robot 100a is finished, the robot 100a holds the cooking utensil t withdrawn from the washing space 402 on the cooking utensil holder 100f.

To this end, the controller 180 may move the end effector 260 such that the cooking utensil t is held on the cooking utensil holder 100f. The controller 180 may calculate a trajectory P4 (holding trajectory P4) where the cooking utensil t is held on the cooking utensil holder 100f.

The controller 180 may calculate the amount of foreign object remaining on the cooking utensil t from the third image and the first image and hold the cooking utensil t on the cooking utensil holder 100f without further washing the cooking utensil t in the sink 100g or the dishwasher 100e′ when the calculated amount of foreign object is less than the lower limit value. In this case, the controller 180 may control the robot 100a such that the cooking utensil t is moved to the holding trajectory P4.

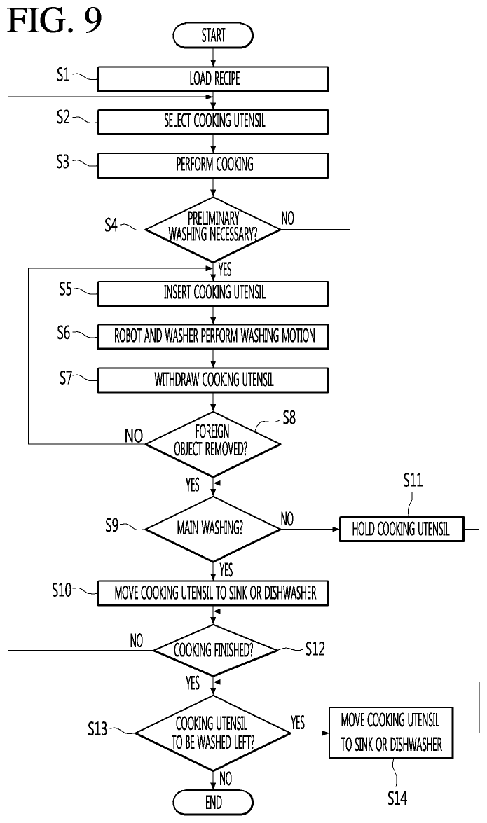

FIG. 9 is a flowchart illustrating a method of controlling a robot system according to an embodiment.

The method of controlling the robot system according to the embodiment may control the robot system including the robot 100a and the washer 400. The robot 100a may include the end effector 260, to which the cooking utensil t is detachably connected. The washing space 402, in which the cooking utensil t is washed, may be formed in the washer 400.

The method of controlling the robot system may include cooking steps S1, S2 and S3, insertion step S5, motion step S6, withdrawal step S7 and movement step S10.

In cooking steps S1, S2 and S3, the robot 100a performs cooking operation using the cooking utensil t.

A user or an administrator (hereinafter referred to as a user) may input cooking information such as desired cooking type or ingredients through the input unit 120, and the controller 180 may download a recipe according to the cooking information input by the user from the memory 170 or may download the recipe from the server 500 to the memory 170 and load the recipe from the memory 170 (S1). The cooking steps S1, S2 and S3 may include a recipe loading process of loading the recipe. The controller 180 may also load an algorithm for selecting the cooking utensil t and washing the cooking utensil t according to the recipe.

The robot 100a and, more particularly, the controller 180 may perform cooking operation according to the loaded recipe, and may select the cooking utensil t used for cooking according to the recipe from among various cooking utensils when the recipe requires the cooking utensil t (S2). The cooking steps S1, S2 and S3 may include a cooking utensil selection step S2 of selecting the cooking utensil.

The entire cooking operation performed by the robot 100a may include various cooking operations performed sequentially and the type of the cooking utensil used by the robot 100a may differ among various cooking operations.

For example, the entire cooking operation performed by the robot 100a may include may include operation of inserting ingredients in a large bowl into a pot, operation of inserting and stirring a ladle, and operation of moving food in the pot to a separate container when cooking is finished.

In this case, the entire cooking operation performed by the robot may be divided into first cooking operation of moving the large bowl (first cooking utensil), second cooking operation of performing specific cooking motion after moving the ladle (second cooking utensil), and third cooking operation of moving the pot to be close to the container and pour the food in the pot into the container or moving the food in the pot into the container using ladle. The cooking utensils used by the robot 100a in the first, second and third cooking operations may be different.

The controller 180 may select the cooking utensil t suitable for current cooking operation.

The controller 180 may operate the robot 100a such that cooking according to the recipe is performed using the selected cooking utensil t, and the robot 100a may perform cooking (S3). The cooking steps S1, S2 and S3 may include a cooking step S3 of using the selected cooking utensil t.

When the cooking step S3 is finished, the controller 180 may operate the robot 100a in a washing mode in which the cooking utensil t used for the cooking operation is washed and hold the cooking utensil ton the cooking utensil holder 100f.

When the cooking step S3 is finished, the controller 180 may differently control the robot 100a according to the amount of foreign object remaining on the cooking utensil t.

For example, when the amount of foreign object remaining on the cooking utensil t is large, the robot 100a may insert the cooking utensil t into the washer 400 to perform preliminary washing and then move the cooking utensil to the sink 100g or the dishwasher 100e′ (S4, S5, S6, S7, S8, S9, and S10).

When the amount of foreign object remaining on the cooking utensil t is small, the robot 100a may move the cooking utensil to the sink 100g or the dishwasher 100e′ (S4, S9 and S10).

When there is no or little foreign object remaining on the cooking utensil t, the robot 100a may hold the cooking utensil t on the cooking utensil holder 100f without moving the cooking utensil t to the washer 400, the sink 100g or the dishwasher 100e′ (S4, S9 and S11).

Hereinafter, washing using the washer 400 and movement to the sink 100g, the dishwasher 100e′ or the cooking utensil holder 100f will be described.

The insertion step S5 may be step in which the end effector 260 inserts the cooking utensil t into the washing space 402.

The insertion step S5 may be performed immediately after the cooking steps S1, S2 and S3, and may be performed when the cooking utensil t needs to be washed by the washer 400.

The controller 180 may determine whether preliminary washing of the cooking utensil t is necessary during or after the cooking operation S3.

The controller 180 may compare images before and after the cooking utensil t is used, and calculate the amount of foreign object adhered to the cooking utensil t (that is, some ingredients adhered to the cooking utensil) through image comparison. The controller 180 may determine whether preliminary washing of the cooking utensil t is necessary according to the amount of foreign object.

The robot system may acquire an image (hereinafter referred to as a first image) of the cooking utensil t before cooking operation is performed and an image (hereinafter referred to as a second image) of the cooking utensil t after cooking operation is performed, by the RGB-D camera sensor.

After the cooking steps S1, S2 and S3, the controller 180 may compare the second image with the first image and calculate the amount of foreign object remaining on the cooking utensil t after the cooking steps S1, S2 and S3.

When the calculated amount of foreign object is equal to or greater than the set value, the controller 180 may determine that the cooking utensil t needs to be preliminarily washed by the washer 400 and the robot 100a (S4).

When the calculated amount of foreign object is equal to or greater than the set value, the controller 180 may perform the insertion step S5. Here, the set value may be a criterion for determining whether the robot 100a preliminarily washes the cooking utensil t using the washer 400.

During the insertion step S5, the controller 180 may move the end effector 260 to the insertion trajectory P1 where the cooking utensil t is inserted into the washing space 402. During the insertion step S5, the controller 180 may control the position and angle of the end effector 260 such that the cooking utensil t is inserted at a predetermined angle.

During the insertion step S5, the angle at which the end effector 260 inserts the cooking utensil t into the washing space 402 may be determined according to a type of the cooking utensil t and a type of the washer.

When the insertion step S5 is finished, the controller 180 may perform the motion step S6. The motion step S6 may be step of operating the end effector 260 in a washing motion.

An example of the washing motion may be a motion in which the end effector 260 rotates above the washing space 402.

Another example of the washing motion may be a motion in which the end effector 260 is lifted up or lowered down above the washing space 402.

Another example of the washing motion may be a combined motion in which the end effector 260 is lifted up or lowered down above the washing space 402 a plurality of times while rotating.

During the motion step S6, the plurality of nozzles 420 of the washer 400 may spray wash water w toward the washing space 402. In addition, during the motion step S6, the washing roller 430 of the washer 400 may be moved in the washing space 402.

During the motion step S6, the cooking utensil t may be three-dimensionally washed by the wash water and the washing roller 430 in the cooking space 302, and the foreign object adhered to the cooking utensil t may be separated from the cooking utensil t.

The motion step S6 may be performed during a set time and may be finished when the set time has elapsed.

The set time may be differently determined according to the amount of foreign object and, for example, the set time when the amount of foreign object is large may be greater than the set time when the amount of foreign object is small.

The controller 180 may wash the cooking utensil tin a plurality of motions, during the motion step S6.

The plurality of motions may include a first motion in which the robot 100a linearly moves and rotates the cooking utensil t, a second motion in which the robot 100a rotates the cooking utensil t, a third motion in which, while the robot 100a rotates the cooking utensil t, the nozzles 420 spray high-pressure wash water, and a fourth motion in which, while the robot 100a linearly moves the cooking utensil t, the nozzles 420 spray high-pressure wash water.

The controller 180 may wash the cooking utensil t in order of the first motion, the second motion, the third motion and the fourth motion.

When washing by the washer 400 and the robot 100a is finished, the withdrawal step S7 may be performed.

The withdrawal step S7 may be step in which the end effector 260 withdraws the cooking utensil t from the washing space 402.

During the withdrawal step S7, the controller 180 may move the end effector 260 to the withdrawal trajectory P2 where the cooking utensil t is withdrawn from the washing space 402.

After the withdrawal step S7, the controller 180 may compare images before and after the cooking utensil t is washed by the washer 400, and check the degree of washing by the washer 400.

The robot system may acquire the image (hereinafter referred to as a third image) of the cooking utensil t after the withdrawal step S7 is performed.

The controller 180 may compare the third image and the first image or the second image to determine whether the foreign object is removed from the cooking utensil t (S8). The controller 180 may perform the foreign object determination step S8 of determining whether the foreign object is sufficiently removed, after the cooking utensil t is washed by the washer 400.

When the calculated amount of foreign object exceeds the set value, since the cooking utensil t is not sufficiently removed by the washer 400, the controller 180 may return to the insertion step S5 and sequentially repeat the insertion step S5, the motion step S6, the withdrawal step S7 and the foreign object determination step S8.

When the calculated amount of foreign object is equal to or less than the set value in the foreign object determination step S8, the controller 180 may finish preliminary washing of the cooking utensil t.

When the calculated amount of foreign object is equal to or greater than the lower limit value and is equal to or less than the set value, the controller 180 may perform the movement step S10.

The movement step S10 may be performed after the withdrawal step S7 and the movement step S10 may be performed when a movement condition is satisfied after the withdrawal step S7. The movement condition may mean that the foreign object remains on the cooking utensil t withdrawn from the washer 400 after being washed in the washer 400 and the amount or thickness of foreign object is in a set range.

The controller 180 may move the end effector 260 to the movement trajectory P3 where the cooking utensil t is put into the sink 100g or the dishwasher 100e′, during the movement step S10.

Meanwhile, when the calculated amount of foreign object is less than the lower limit value, since the foreign object is sufficiently removed by the washer 400, the controller 180 may hold the cooking utensil t on the cooking utensil holder 100f without further washing the cooking utensil t(S9 and S11).

When the calculated amount of foreign object is less than the lower limit value, the controller 180 may perform the holding step S11. During the holding step S11, the controller 180 may move the end effector 260 to the holding trajectory P4 where the cooking utensil t is held on the cooking utensil holder 100f.

The method of controlling the robot system may return to the cooking step and, more particularly, the cooking utensil selection step S2, for next cooking operation, when cooking (that is, the entire cooking operation) is not finished after the cooking utensil t is moved to the sink 100g, the dishwasher 100e′ or the cooking utensil holder 100f (S12 and S12).

The method of controlling the robot system may further include sensing and determining when there is another cooking utensil to be washed around the robot 100a when cooking (that is, entire cooking operation) is finished (S13).

The sensing unit 140 may transmit the sensing value to the controller 180, and the controller 180 may operate the robot 100a such that the robot grips and moves the other cooking utensil to the washer 400, the sink 100g or the dishwasher 100e′, when there is another cooking utensil to be washed around the robot 100a (S13 and S4).

The method of controlling the robot system may further include finishing cooking using the robot 100a and setting the robot in a standby mode, when cooking (that is, entire cooking operation) is finished and there is no cooking utensil to be washed around the robot 100a.

According to the embodiment, the robot may perform cooking operation using the cooking utensil, insert the cooking utensil adhered with the foreign object into the washer, thereby conveniently removing the foreign object in the washer.

In addition, since the robot and the washer operate together to remove the foreign object from the cooking utensil, it is possible to more rapidly separate the foreign object from the cooking utensil.

In addition, it is possible to reliably separate the foreign object from the cooking utensil by a combination of rotation or elevation of the cooking utensil and wash water or the washing roller.

In addition, since the cooking utensil preliminarily washed in the water is moved to the sink or the dishwasher, it is possible to further wash the cooking utensil more cleanly.

The foregoing description is merely illustrative of the technical idea of the present disclosure and various changes and modifications may be made by those skilled in the art without departing from the essential characteristics of the present disclosure.

Therefore, the embodiments disclosed in the present disclosure are intended to illustrate rather than limit the technical idea of the present disclosure, and the scope of the technical idea of the present disclosure is not limited by these embodiments.

The scope of protection of the present disclosure should be construed according to the following claims, and all technical ideas falling within the equivalent scope to the scope of protection should be construed as falling within the scope of the present disclosure.

What is claimed is:

1. A robot system comprising:
a robot having an end effector, to which a cooking utensil is detachably connected;
a washer having formed therein a washing space in which the cooking utensil is washed; and
a controller configured to operate the robot in a washing mode in which the cooking utensil is inserted into the washing space and then is washed in the washing space.

2. The robot system according to claim 1, wherein, in the washing mode of the robot, the controller moves the end effector to an insertion trajectory where the cooking utensil is inserted into the washing space, and then operates the end effector in a washing motion.

3. The robot system according to claim 1, wherein an angle at which the end effector inserts the cooking utensil into the washing space is determined according to a type of the cooking utensil and a type of the washer.

4. The robot system according to claim 1, wherein, during the washing mode of the robot, the controller rotates the end effector in a rotational motion in which the end effector rotates above the washing space.

5. The robot system according to claim 1, wherein, during the washing mode of the robot, the controller lifts up or lowers down the end effector in an elevating motion in which the end effector is lifted up or lowered down above the washing space a plurality of times.

6. The robot system according to claim 1, wherein, when the washing mode of the robot is finished, the controller moves the end effector to a withdrawal trajectory where the cooking utensil is withdrawn from the washing space.

7. The robot system according to claim 1, wherein, when the washing mode of the robot is finished, the controller puts the cooking utensil into a sink or a dishwasher.

8. The robot system according to claim 1,
wherein the washer is spaced apart from the robot by a first distance, and
wherein the first distance is less than a maximum length of the robot.

9. The robot system according to claim 1, wherein the washer includes:
a washer controller configured to control the washer, and
a communication device configured to communicate with the robot.

10. The robot system according to claim 1, wherein the washer includes:
a washing housing having an opened upper surface and having the washing space formed therein; and
a plurality of nozzles disposed in the washing housing to spray wash water toward the washing space.

11. The robot system according to claim 1, wherein the washer includes:
a washing housing having an opened upper surface and having the washing space formed therein; and
at least one washing roller disposed to advance to or retreat from the washing space in the washing housing.

12. A method of controlling a robot system including a robot having an end effector, to which a cooking utensil is detachably connected, and a washer having formed therein a washing space in which the cooking utensil is washed, the method comprising:
performing cooking operation using the cooking utensil by the robot;
inserting the cooking utensil into the washing space by the end effector;
operating the end effector in a washing motion; and
withdrawing the cooking utensil from the washing space by the end effector.

13. The method according to claim 12, wherein the inserting of the cooking utensil includes moving the end effector to an insertion trajectory where the cooking utensil is inserted into the washing space.

14. The method according to claim 12, wherein the inserting of the cooking utensil includes determining an angle, at which the end effector inserts the cooking utensil into the washing space, according to a type of the cooking utensil and a type of the washer.

15. The method according to claim 12, wherein, in the washing motion, the end effector rotates above the washing space.

16. The method according to claim 12, wherein, in the washing motion, the end effector is lifted up or lowered down above the washing space a plurality of times.

17. The method according to claim 12, wherein the operating of the end effector in the washing motion includes spraying wash water toward the washing space by a plurality of nozzles of the washer.

18. The method according to claim 12, wherein the operating of the end effector in the washing motion includes moving a washing roller of the washer in the washing space.

19. The method according to claim 12, wherein the withdrawing of the cooking utensil includes moving the end effector to a withdrawal trajectory where the cooking utensil is withdrawn from the washing space.

20. The method according to claim 12, further comprising, after the withdrawing of the cooking utensil, moving the end effector to a movement trajectory where the cooking utensil is put into a sink or a dishwasher.
